(19) United States
(12) Patent Application Publication
(10) Pub. No.: US 2010/0065535 A1
(43) Pub. Date: Mar. 18, 2010

(54) METHOD AND APPARATUS FOR GENERATING A PLASMA FIELD

(75) Inventors: Wenxin Zheng, Ellicott City, MD (US); Douglas Duke, Simpsonville, SC (US); William R. Klimowych, Greenville, SC (US); Toshiki Kubo, Greer, SC (US)

Correspondence Address: SUGHRUE MION, PLLC, 2100 PENNSYLVANIA AVENUE, N.W., SUITE 800, WASHINGTON, DC, 20037, US

(73) Assignee: AFL Telecommunications LLC, Spartanburg, SC (US)

(21) Appl. No.: 12/513,628

(22) PCT Filed: Jul. 18, 2008
(86) PCT No.: PCT/US08/70492

§ 371 Date: May 5, 2009

Related U.S. Application Data
(60) Provisional application No. 60/950,551, filed on Jul. 18, 2007.

(51) Int. Cl. H05H 1/00; H05B 7/00; B23K 10/00

(52) U.S. Cl. 219/121.38; 219/121.59; 219/121.52; 219/121.46; 219/121.41

(57) ABSTRACT

A method and associated apparatus for generating a plasma field, including: arranging the points of discharge of a plurality of electrodes into a plane, applying voltage to each electrode, providing at least one grounded electrode, and controlling the path between the electrodes and corresponding temperature of the plasma formed between the electrodes by controlling the signal and phase to the high voltage generators.

### CROSS-REFERENCE TO RELATED APPLICATIONS

This application claims priority from U.S. Provisional Application No. 60/950,551 filed on Jul. 18, 2007, the disclosure of which is herein incorporated by reference.

### BACKGROUND OF THE INVENTION

1. Field of Invention

Methods consistent with the present invention relate to creating an arc-discharge induced plasma field. The heated plasma field is useable for a variety of materials processing applications such as drawing and tapering a glass rod to a smaller diameter, joining two or more glass rod or tube elements together to form a single fused entity, stripping coatings off of underlying materials, reshaping materials, and material surface polishing, etching, and cleaning. These many applications may be accomplished by tailoring the energy intensity and temperature as well as the shape and size of the plasma field. The method uses arcs discharged between electrodes to form a plasma field.

2. Background and Description of Related Art

Fusion splicing of optical fibers is the most common method of joining optical fibers in order to build communications networks. This method came into use in the late 1970s and has been refined since that time. Fusion splicing provides a reliable fiber joint, and in its modern incarnation, is relatively easy to perform by semi-skilled labor.

Fusion splicing is also commonly employed in factory or laboratory use for creating fiber optic and photonic assemblies using optical fibers. The fiber-optic assemblies may be intended for telecommunication systems, or they may provide utility for a variety of industrial fiber-optic applications.

In any case, the optical fibers must be prepared for splicing by first stripping the protective plastic coating off of the fibers, and then cleaving the fibers to produce a flat endface on the fiber ends perpendicular to the axis of the fiber. This fiber preparation process produces two opposing fiber ends that are suitable for being welded together into a continuous fiber by the fusion splicing process.

Fusion splicing is typically performed with fusion splicers that utilize a high voltage arc discharge to create a plasma field. Typically an anode/cathode electrode arrangement is used with an arc circuit generating a high voltage which then creates an arc to the grounded opposite electrode. The arc creates a plasma field of ionized air molecules, which heats the optical fibers as they are driven together by the motor drives of the fusion splicer.

Typical plasma arcs for fusion splicing are generated by a flyback transformer, basically the same technology as utilized in a Cathode Ray Tube (CRT). The basic schematic for a typical flyback transformer used to generate the high voltage for the arc is shown in FIG. 1. The plasma field 300 generated by the high voltage circuit 310 must be hot enough to generate sufficient energy to melt and fuse the silica glass fibers between the tips of two electrodes 320 and 330 shown in FIG. 2. This requires a temperature of more than 1600° C., which is easy to achieve with the arc fusion process.

The fiber preparation process is typically achieved using hand-held or bench-top tools.

Stripping the fibers is most commonly performed using a simple hand stripping tool analogous to a wire stripper. The stripping tool employs blades that cut into the plastic coating, creating a deep deformation and tear that allows the plastic coating to be pulled and sheared away from the underlying glass fiber from the tear point to the end of the fiber.

In some more elaborate stripping tools, a heating element is used prior to the shearing action. This reduces the required shear force as the heat causes the plastic coating to swell and lose adhesion due to the much greater coefficient of thermal expansion of the plastic coating relative to that of the glass fiber. This thermally assisted stripping method is most commonly employed for stripping multiple optical fibers simultaneously, as in the case of preparing a multi-fiber ribbon array for splicing.

After stripping, plastic coating remnants remain on the fiber. These must be removed prior to cleaving the fiber or splicing. The fiber cleaning process is most commonly achieved by wiping the fibers with an alcohol-moistened tissue. Another method involves immersion of the stripped fiber in an ultrasonic cleaning bath in which the ultrasonic agitation of the cleaning fluid, typically alcohol, bombards and dislodges the particles of coating residue.

Use of an electrical discharge arc to create a plasma field similar to that of a fusion splicer has also been employed for either cleaning or stripping optical fibers, especially in the case of fibers coated with special high temperature resistant Polyimide coating. In some cases wherein a plasma field has been used for fiber stripping or cleaning, the energy of the plasma field has been optimized by design to a lower temperature, or the placement of the fiber has been located at the outer area of the plasma field where the energy is lower. This can provide energy sufficient to strip or clean the fiber without melting the glass itself.

Cleaving the fiber is typically performed by mechanical means using a tool to scribe the surface of the glass, forming a small crack, and then applying stress to the fiber to propagate the crack and thereby cleave the fiber.

While fusion splicing is well accepted in the market and dominates splicing applications for optical fibers, it does have shortcomings.

One method of conducting fusion splicing is that of 3 SAE's RING OF FIRE™ configuration, in which points of discharge of three electrodes are arranged into a T or Y shape configuration. The three electrodes are operated via a three-phase electrical configuration. In order to make the three-phase configuration work, each electrode must be powered by a high voltage high frequency (˜30 kHz) power supply, such that each electrode is modulated 120 degrees out of phase relative to the other two electrodes. The drawback of this configuration is that the current and voltage modulation of the electrodes must be carefully phased and precisely controlled in a three-phase architecture in order to create a plasma field.

Furthermore, although the extremely hot arc of a conventional fusion splicer works well for splicing common 125 μm diameter silica-glass telecommunications type optical fiber, it not suitable for splicing fibers with different material composition (and lower melting points for example) such as phosphate glass fibers. If the power of the fusion arc is reduced, it becomes unstable and incapable of generating a plasma field. There are also practical limitations on how much energy arc fusion can generate. Therefore there are limitations on how large a fiber may be spliced using conventional arc fusion. Arc fusion splicing has been demonstrated for silica-based optical fibers of diameters up to 800 μm for example. However, fibers of much greater diameter are increasingly required for fiber-laser applications, and sometimes for medical uses of optical fiber.

Another problem with conventional arc fusion splicing is the reliability and stability of the condition of the electrodes. The condition of the electrodes greatly affects the energy output of the electrodes, as well as the directional path of the arc, and therefore the position of the arc relative to the fibers. The plasma field is not uniform in energy intensity or temperature, and hence the position of the plasma field relative to the fiber position greatly affects the amount of energy transferred to the fiber during the arc fusion process.

The condition of the electrodes is changed due to two primary factors. One factor is that some of the silica glass is vaporized during each fusion splice. Some of this vaporized glass will be deposited on the tips of the electrodes. This deposition is variable with each arc, and therefore leads to instability in the total heat output and also instability of the path of the arc. Secondly, the electrode tips themselves, which are initially sharply pointed with a conical tip, erode and round off non-uniformly over time. This gradually increases the gap between the electrode tips as the ends round-off, thereby increasing the electrical potential and changing the heat output relative to the applied electrical power from the arc discharge circuit. It also results in further instability of the arc path since the arc no longer emanates from a single point on a sharp electrode tip, but instead from some random positions on the non-uniformly rounded tip of the electrode.

Various methods are commonly utilized to try to calibrate the arc discharge to compensate for electrode wear. These methods are imperfect and typically require actions which may be overlooked by untrained or semi-skilled operators. Also, the electrodes must be replaced at regular intervals, typically after 1000 splices. The electrode replacement, as well as the subsequent electrode stabilization and calibration process, is somewhat tedious and is often overlooked by untrained operators or neglected until long after the recommended electrode life has been exceeded.

Common stripping methods generally work fairly well for typical telecommunications fiber applications and field use. Hand stripping tools are usually easy to use and fairly intuitive to operate. However, the shearing action used to pull the coating off the glass fiber abrades the surface of the glass, resulting in a significant decrease in strength. This is true even for thermally assisted stripping tools, even though the shear force is decreased by the thermal expansion of the plastic coating. Subsequent cleaning of the fibers either by wiping by hand or by use of an ultrasonic cleaner further degrades the fiber strength.

For general telecommunications fiber splicing in field conditions, these methods are generally acceptable because the strength of the splice joint will be enhanced and protected by application of a splice protection device. Nevertheless, the stripping and cleaning process represents one of the greatest sources of user sensitivity in the splicing process. It often results in mechanical failure of the splice. Also, failure to thoroughly clean off residual coating debris, or incomplete stripping, results in increased optical loss in the fusion splice. Also the residual coating debris contamination can be transferred to and can remain in the fusion splicer, resulting in significant fusion splicer maintenance problems. Stripping and/or cleaning the fiber using an arc discharge presents its own set of problems. The energy from the arc of a typical arc fusion splicer is so hot that it will damage the surface of the glass fiber. Furthermore, such an arc cleaning process will ignite the plastic coating residue and burn it at such a high temperature that it will create a localized hot spot within the structure of the glass fiber itself. This can lead to distortion within the fiber structure and therefore significant power loss in the transmitted optical signal. If the design of an arc device is optimized for fiber stripping and cleaning with a lower energy transfer to the fiber, it will be unusable for other applications such as fusion splicing, which requires a higher energy transfer in order to completely melt and weld the glass fiber. In that case, a relatively large and expensive tool, similar in size and expense to a fusion splicer, will be dedicated only to the fiber preparation process, replacing simple and inexpensive hand tools normally employed for fiber preparation.

Use of an electrical arc or plasma field of a fusion splicer (or in a device with a plasma field induced by a pair of electrodes in a similar fashion to a fusion splicer) has been used for tapering optical fibers as well as glass rods and tubes. This is accomplished by applying a tensile force to the glass fiber, rod or tube simultaneous with the application of heat by the plasma field. By this method a tapered reduction of the original diameter can be achieved, and, if desired, a uniform smaller diameter can be output over some length from a larger original diameter. This method can also be applied in order to join and taper multiple input fibers, rod and/or tubes into a fused single output. This is sometimes referred to as a fused and tapered fiber bundle or a combiner.

The tapering and drawing process operations as described above are also sometimes performed using a heat source other than a plasma field created by an electrical arc discharge. In the case of drawing a long length of small diameter optical fiber from the relatively very large original glass preform, a gas flame or carbon heater is commonly used. Other heating methods include metallic filaments, radiant and/or ceramic heaters, or the application of heat by use of a laser. These methods may eliminate some of the drawbacks previously noted concerning the plasma field; however, each method has its own drawbacks. Depending upon the method employed, drawbacks may include large size and weight (and loss of portability), cost, mechanical and control complexity, operational sensitivity to the environment including in some cases a requirement for an inert gas environment, and possibly a need for tightly controlled process parameters.

Use of an electrical arc or plasma field of a fusion splicer (or in a device with a plasma field induced by a pair of electrodes in a similar fashion to a fusion splicer) has been used for the purpose of heating an optical fiber along some portion of its length in order to induce diffusion of the glass fiber core dopant materials into the adjacent cladding region. This has the effect of expanding the fiber core and mode field diameter (MFD). Such a fiber treatment may be beneficial for reduced optical signal loss when the fiber will be subsequently joined or spliced to another fiber that has a relatively larger core and MFD. If the expanded MFD of the pre-heated fiber more closely matches the larger core of the second fiber, the optical loss will be reduced. This result of the application of this method is commonly referred to as Thermally Expanded Core (TEC). The overall method is similar to the aforementioned tapering but does not require the simultaneous application of a tensile force since there is no requirement to reduce the overall diameter of the glass rod or fiber.

All of the previously noted heating methods that may be used as an alternative to a plasma field for tapering operations (flame, radiant heater, laser, filament, carbon heater, etc.) may also be utilized to thermally expand the core and MFD of an optical fiber. The same relative merits and drawbacks apply.

A common practice with optical fibers is to couple two (and sometimes multiple) fibers together with a fused and tapered joining of the fibers in order to achieve the combining of the optical power (or optical wavelengths, or polarized light states) within each individual fiber into one or more combined outputs. Such as fused and tapered optical device is often referred to as a coupler. Alternatively, already combined optical power, wavelengths and polarization states may be split among 2 or more outputs in an analogous device commonly referred to as a splitter. All of these devices may generically be referred to as fused and tapered optical fiber devices. Such fused and tapered optical couplers, polarization combiners and splitters, etc are most commonly heated during the tapering and joining process using either a gas flame or a radiant heater such as a ceramic heater. Up to now, heating using a plasma field has been typically unsuitable because the shape of the plasma field as generated by the electrical discharge arc from a pair of electrodes is relatively narrow and does not heat the fibers over a sufficient length. A longer heating length is generally desirable for achieving a controlled and gentle taper of the fibers during the manufacturing process.

Material surface processing and controlled shape modification of a suitable material may be achieved by application of heat to the material surface. An example is heating the end of an optical fiber such that the surface tension of the molten glass draws the end of the fiber into a spherical ball lens. This may be achieved with controlled application of heat by any of the methods described above, including the use of a plasma field. The necessary application of heat depends upon the material properties, and the proper control of the thermal energy application may be difficult depending upon the beginning shape of the material to be modified. While a fiber end may be reshaped into a spherical ball lens using a conventional plasma field (as generated by a pair of electrodes), in other cases such a conventional plasma field may be unstable or the path or position of the plasma field may be altered or may be destabilized by the shape of the object or by other environmental factors.

Material processing other than welding (including optical fiber splicing), stripping, tapering, etc. may also be achieved by use of a plasma field. For example, the relatively cold plasma field induced using a microwave or RF energy source is commonly used for surface cleaning and etching in the production and cleaning of micro-electronic circuits, wafers, and chips. The plasma field generated by the electrical arc discharge of a pair of electrodes is typically not useful for such applications due to the difficulty in controlling the shape and position of the plasma field, as noted above. The plasma field emanating from a pair of electrodes is typically easily influenced by materials and surfaces in its proximity. It is therefore usually unstable and poorly controlled for many cleaning and etching applications for which a plasma field generated by an RF emitter is well suited.

### SUMMARY OF THE INVENTION

A new invention employing a new and novel arc discharge technology is described herein.

The invention involves the use of multiple electrodes utilized in conjunction with a new arc circuit design and new algorithms to control and modulate the arc. As shown in the exemplary embodiment of FIG. 3, four electrodes 10, 20, 30, and 40 are arranged such that an arc discharge is created between their points of discharge. Three electrodes (20, 30, and 40) are connected to three conventional high voltage circuits 1, respectively, and one electrode 10 is connected to the ground. This configuration generates a plasma field 100 between the points of discharge of the electrodes, and allows the integrity of the plasma field 100 of ionized air molecules at the to be maintained with great stability.

The conventional high voltage generators 1 can either be operated continuously at the “ON” stage, or modulated quickly on and off at a frequency of up to 1 MHz, with an adjustable duty cycle. It is possible to operate each generator at a lower electrical power (low duty cycle) and still maintain a stable ionized plasma shape at the center of the arc. Hence, this method allows a controllable arc at a low energy level, while still allowing operation at a very high power level if required. The three generators can not only be pulsed out of phase with each other, but the total arc, comprising operation of all generators in out-of-phase operation, can also be pulsed on and off in order to control the total arc duty cycle, thereby offering greater energy control.

Furthermore, the structure of the multiple electrodes is very flexible. For example, the number of electrodes can be decreased or increased. One structure with 3 electrodes is shown in FIG. 4. The electrodes do not need to be located on the same plane (2 dimensional). The electrodes can be configured in any shape in a 3 dimensional space for different applications. One example is shown in FIG. 5 for a tetrahedron shape with 4 electrodes.

A method for generating a plasma field in keeping with the present invention includes arranging at least three electrodes to create an arc discharge; connecting at least one of the electrodes to ground; and applying voltage to each electrode not connected to ground.

Preferably, each electrode not connected to ground receives voltage from a power supply independent of the other electrodes.

In one embodiment of the method, only one electrode is connected to ground.

Preferably, the power of the plasma field is controlled by varying an applied signal.

Preferably, at least one of the power, intensity, shape, and the size of the plasma field is varied in relation to the number of electrodes to which voltage is applied.

Preferably, the power of the plasma field is controlled by modulating an applied signal.

The plasma field may have a temperature and shape suitable for splicing optical fibers.

The plasma field may have a temperature and shape suitable for stripping a coating layer off of an underlying material.

The plasma field may have a temperature and shape suitable for tapering optical fibers, rods, or tubes.

The plasma field may have a temperature and shape suitable for fusing together and tapering a plurality of at least one of optical fibers, rods, and tubes.

The plasma field may have a temperature and shape suitable for thermally expanding the core and mode field diameter of an optical fiber.

The plasma field may have a temperature and shape suitable for softening or partially melting and thereby reshaping an object.

This object may be an optical fiber.

The plasma field may have a temperature and shape suitable for softening or partially melting and thereby polishing the surface of an object.

This object may be at least one of an optical fiber and optical fiber connector end.

The plasma field may have a temperature and shape suitable for cleaning or etching the surface of an object.

This object may be an optical fiber.

Another method for generating a plasma field in keeping with the present invention includes arranging at least four electrodes to create an arc discharge; connecting at least one of the electrodes to ground; and applying voltage to each electrode not connected to ground, wherein points of discharge of at least three of the electrodes define a plane, and wherein a point of discharge of at least one of the electrodes is disposed outside of the plane.

Preferably, each electrode not connected to ground receives voltage from a power supply independent of the other electrodes.

In one embodiment of the method, only one electrode is connected to ground.

Preferably, the power of the plasma field is controlled by varying an applied signal.

Preferably, at least one of the power, intensity, shape, and the size of the plasma field is varied in relation to the number of electrodes to which voltage is applied.

Preferably, the power of the plasma field is controlled by modulating an applied signal.

The plasma field may have a temperature and shape suitable for splicing optical fibers.

The plasma field may have a temperature and shape suitable for stripping a coating layer off of an underlying material.

The plasma field may have a temperature and shape suitable for tapering optical fibers, rods, or tubes.

The plasma field may have a temperature and shape suitable for fusing together and tapering a plurality of at least one of optical fibers, rods, and tubes.

The plasma field may have a temperature and shape suitable for thermally expanding the core and mode field diameter of an optical fiber.

The plasma field may have a temperature and shape suitable for softening or partially melting and thereby reshaping an object.

This object may be an optical fiber.

The plasma field may have a temperature and shape suitable for softening or partially melting and thereby polishing the surface of an object.

This object may be at least one of an optical fiber and optical fiber connector end.

The plasma field may have a temperature and shape suitable for cleaning or etching the surface of an object.

This object may be an optical fiber.

An apparatus for generating a plasma field in keeping with the present invention includes a power supply; at least two powered electrodes connected to the power supply; and at least one grounded electrode connected to ground, wherein a point of discharge of each of the powered electrodes and a point of discharge of the at least one grounded electrode are arranged to create an arc discharge between points of discharge.

Another apparatus for generating a plasma field in keeping with the present invention includes a power supply; at least three powered electrodes connected to the power supply; and at least one grounded electrode connected to ground, wherein the point of discharge of the powered electrodes and a point of discharge of the at least one grounded electrode are arranged to create an arc discharge between the points of discharge, wherein the points of discharge of at least three of the electrodes are arranged to form a plane, and wherein the point of discharge of at least one of the electrodes is disposed outside of the plane.

Another method for generating a plasma field in keeping with the present invention includes arranging point of discharge of two pairs of electrodes to create an arc discharge between the points of discharge; and applying voltage alternately between the pairs of electrodes at a predetermined frequency.

Preferably, when voltage is applied to an electrode pair, one electrode is connected to positive voltage and the other electrode is connected to negative voltage.

Preferably, a straight path of plasma is formed between opposing electrodes, and peripheral paths of plasma are formed between nonopposing electrodes.

Preferably, one electrode in each pair is continuously grounded.

Another method for generating a plasma field in keeping with the present invention includes arranging points of discharge of a first and second pair of electrodes to create an arc discharge between the points of discharge; applying a positive voltage to the first electrode pair; and applying a negative voltage to the second electrode pair.

Another method for generating a plasma field in keeping with the present invention includes arranging points of discharge of a first and second pair of electrodes to create an arc discharge between the points of discharge; and applying an equal voltage to the first and second electrode pair, wherein the voltage applied to one electrode pair is out of phase with the voltage applied to the other electrode pair.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a circuit diagram of conventional fusion splicer.

FIG. 2 is a diagram of conventional plasma discharge structure with 2 electrodes.

FIG. 3 illustrates the wiring of the first exemplary embodiment of the invention with 4 electrodes.

FIG. 4 illustrates the wiring of a second exemplary embodiment of the invention with 3 electrodes.

FIG. 5 illustrates the wiring of a third exemplary embodiment of the invention with 4 electrodes deployed in a 3 dimensional space to form plasma cloud in a tetrahedron shape.

FIGS. 6A and 6B illustrate the relative temperatures of two regions of an exemplary embodiment of the invention.

FIG. 7 illustrates a block diagram of an exemplary control circuit for controlling the output of the exemplary embodiments of the invention.

FIG. 8 illustrates the wiring of a fourth exemplary embodiment of the invention.

FIGS. 9A and 9B illustrate the arc paths in fourth exemplary embodiment of the invention over a period of time, and the associated signal waveforms.

FIG. 10 illustrates a method of mounting the electrodes of the first exemplary embodiment of the invention.

FIG. 11 illustrates the wiring of a fifth exemplary embodiment of the invention.

FIG. 12 illustrates the arc paths in the fifth exemplary embodiment of the invention.

FIG. 13 illustrates the arc paths of a sixth exemplary embodiment of the invention.

FIG. 14 illustrates the relative temperatures of two regions of the sixth exemplary embodiment of the invention.

FIG. 15 illustrates a fiber stripper according to an exemplary embodiment of the invention.

FIGS. 16A and 16B illustrate plan and side views of a fiber preparation system according to an exemplary embodiment of the invention.

### DETAILED DESCRIPTION OF EXEMPLARY EMBODIMENTS OF THE INVENTION

### First Exemplary Embodiment of the Invention

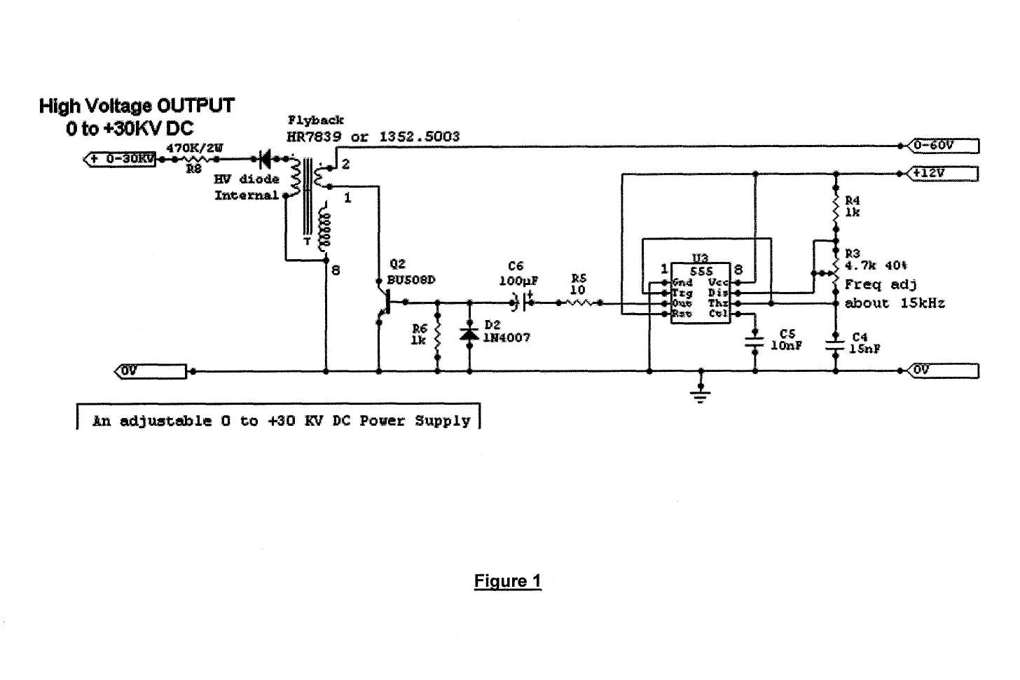

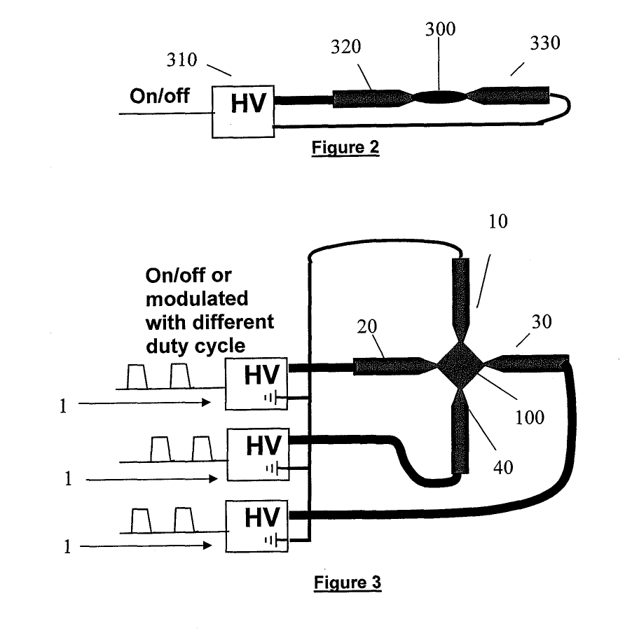

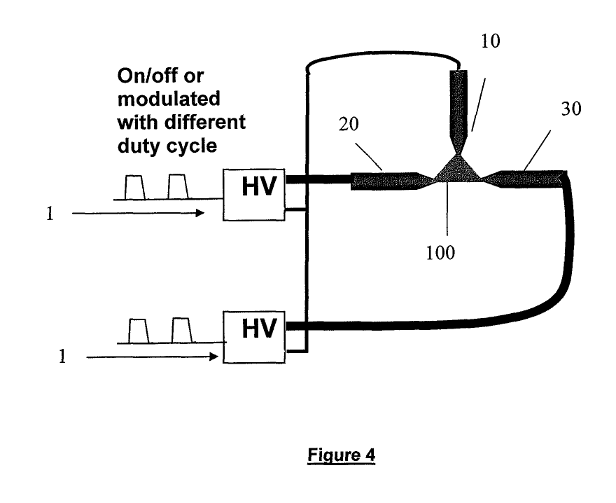

In the case of the first exemplary embodiment of the invention shown in FIG. 3, three (3) high voltage generators 1 are utilized. Each high voltage generator 1 (which, for example, may be a flyback transformer) is dedicated to a separate electrode. In comparison, in a typical arc circuit for a normal commercially available arc fusion splicer, only one high voltage generator 1 is utilized, as seen in FIGS. 1 and 2. It sends the high voltage power to one electrode 20 which in turn arcs across to the grounded electrode 10.

In the case of the first exemplary embodiment of the present invention, shown in FIG. 3, three of the electrodes 20, 30, and 40 are powered with a voltage (for example, ±10 kv). These electrodes 20, 30, and 40 share a common ground electrode 10. The resulting plasma field 100 formed between the electrodes is effectively double the size of the RING OF FIRE™ configuration, while using the same number of high voltage generators.

The power and duration of the plasma field can be controlled by pulsing the arc discharge. However, neither current nor voltage modulation is required to create the plasma field 100 shown in FIG. 3. Each high voltage generator 1 can be operated at a different duty cycle of AC current. Alternatively, the high voltage generators can be run on DC current. The signal to the high voltage generators 1 is modulated only to change the power of the plasma field. It is not a necessary condition for operation.

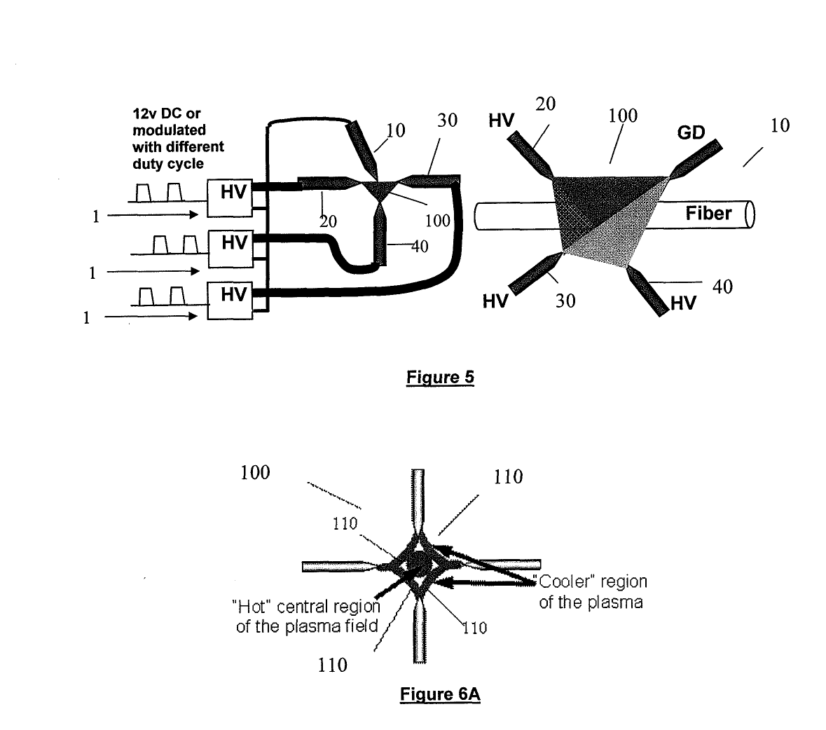

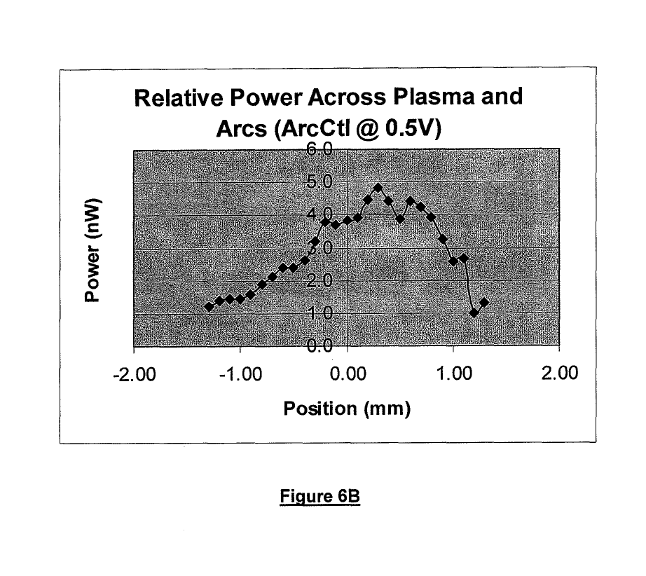

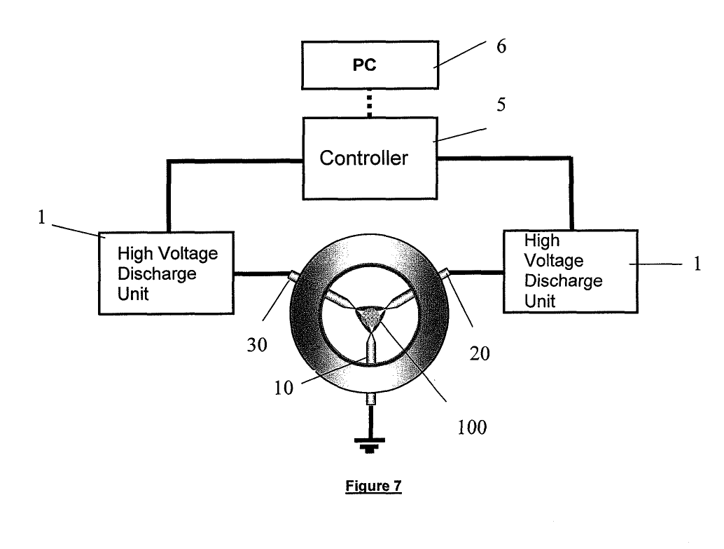

This particular configuration generates plasma arcs 110 formed between adjacent electrodes, as shown in FIG. 6A. This results in a temperature spread across the plasma field 100 like that depicted graphically in FIG. 6B. The center of the plasma field 100 is the hottest, while the arcs 110 between the electrodes are relatively cooler.

Similarly, the configuration of the electrodes can also be changed depending on the application. Although the electrodes shown in FIGS. 3 and 4 are configured in X or T shapes such that the electrodes are perpendicular to one another, the electrodes can be arranged in any configuration, as needed for a given application. For the first exemplary embodiment, only the points of discharge of the three electrodes must be coplanar. The bodies of the electrodes need not be coplanar.

Since each electrode must be at ground potential when not powered or during the “OFF” period of a cycle, each electrode must be electrically isolated to a high degree of isolation. This can be achieved by mounting the electrodes in a simple ring 4 as shown in FIG. 10, made of a suitable insulating material that can withstand high temperatures, such as ceramic.

In the case of a fusion splicer application, a continuous ring 4 as shown in FIG. 10 may not be possible, since it would not permit the fibers to be inserted and removed. Preferably, at least one of the electrodes would be similarly isolated in a separate portion of the ring 4, and mounted on a hinged assembly to permit opening up the “ring” to allow insertion and removal of the fibers. Alternatively, the “ring” could take more of the shape of the letter “C”, with the opening at the top.

### Second Exemplary Embodiment

The number of electrodes affects the size and shape of the plasma field 100. In the second exemplary embodiment illustrated in FIG. 4, only three electrodes 10, 20, and 30 are used. Two of these electrodes 20 and 30 are connected to high voltage generators 1, and share a common ground electrode 10. This embodiment uses one less high voltage generator 1, although the effective area of the plasma field 100 is half that of the embodiment shown in FIG. 3.

### Third Exemplary Embodiment

In the third exemplary embodiment illustrated in FIG. 5, four electrodes 10, 20, 30, and 40 are arranged into a three-dimensional configuration. Three of the electrodes 20, 30, and 40 are connected to high voltage generators 1, controlled in Direct Current (DC) or pulsed mode. Any modulation of the current is necessary only to control the power of the plasma field 100 generated. A fourth, grounded electrode 10 is provided out of plane with the three electrodes 20, 30, and 40. The resulting plasma field 100 has a tetrahedral shape, and represents an increase in fiber heating area over the embodiment illustrated in FIG. 3. This structure is suitable for core diffusion and MFD expansion. It can also function as a suitable replacement for flame fiber diffusion.

It will be appreciated that different shapes of the plasma field 100 can be achieved, by providing electrodes in any three-dimensional configuration as required by a given application.

### Fourth Exemplary Embodiment

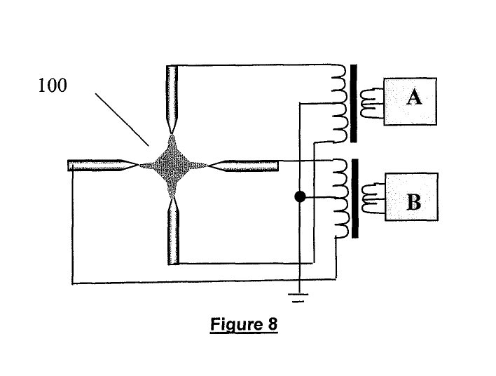

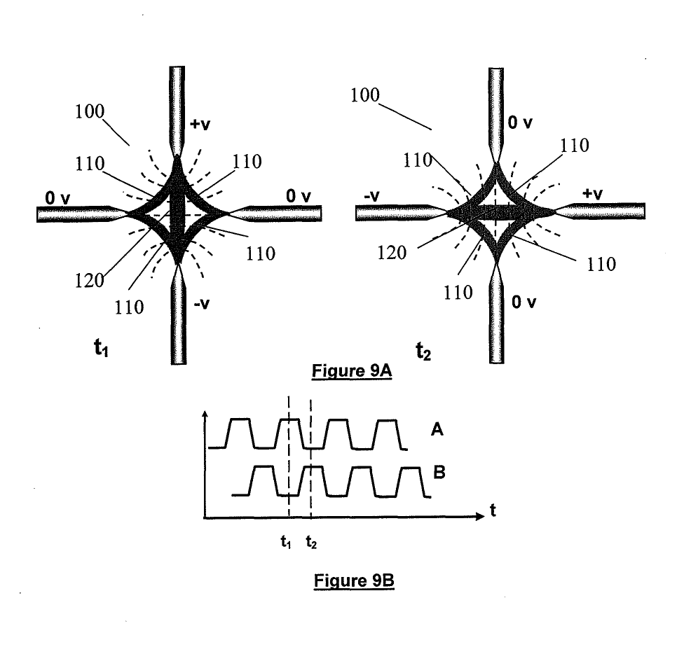

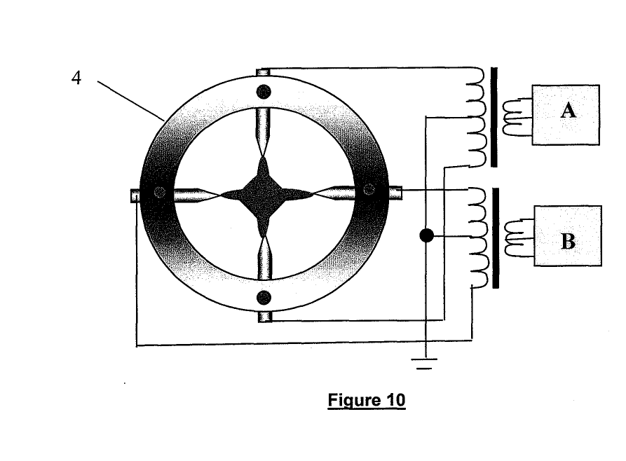

The connection of the electrodes to the high voltage generators 1 can also be varied, based on the application. In the case of the fourth exemplary embodiment of the present invention, shown in FIG. 8, when one pair of electrodes (Circuit A) is “ON”, one electrode is powered with a positive voltage (for example, +10 kv) and the opposite electrode is energized to a negative voltage (for example, −10 kv). Meanwhile, the other pair of electrodes (Circuit B) is “OFF”. In the next instant of operation, Circuit B is “ON” and Circuit A is “OFF”. The time-sequence of this operation can be seen in FIGS. 9A and 9B, illustrating the arcs and the signal waveforms, respectively.

As this method is utilized, a straight path 120 is formed as the main arc path, going from the positively charged electrode to the opposed negatively charged electrode. Secondary/peripheral arc paths 110 will be formed between adjacent electrodes, going from the charged electrodes to the uncharged (grounded) electrodes on the perpendicular axis. All of these arc paths are clearly shown in FIG. 9A for both time t1 when arc Circuit A is energized and also for t2 when arc Circuit B is energized. The associated signal waveforms are shown in FIG. 9B. The peripheral arcs 110 from charged electrodes to uncharged electrodes form in both cases, but the main arc 120 from positively charged to negatively charged electrodes flips 90 degrees every time the energized circuit changes from A to B. By alternating these plasma fields, a plasma field 100 of ionized air molecules will be created at the center of the “X” axis. Since the area of ionized air is maintained, a relatively low electrical power will be sufficient to maintain the plasma field continuously, resulting in a low energy level.

### Fifth Exemplary Embodiment

In the fifth exemplary embodiment of the invention, only two discrete high voltage generators 1 are used, as shown in FIG. 11. In this exemplary embodiment, two pairs of adjacent electrodes are each tied to an individual high voltage generator 1. Alternatively, two pairs of opposed electrodes could each be tied to the individual high voltage generators 1. As seen in FIG. 11, one electrode in each high voltage circuit is continuously tied to ground.

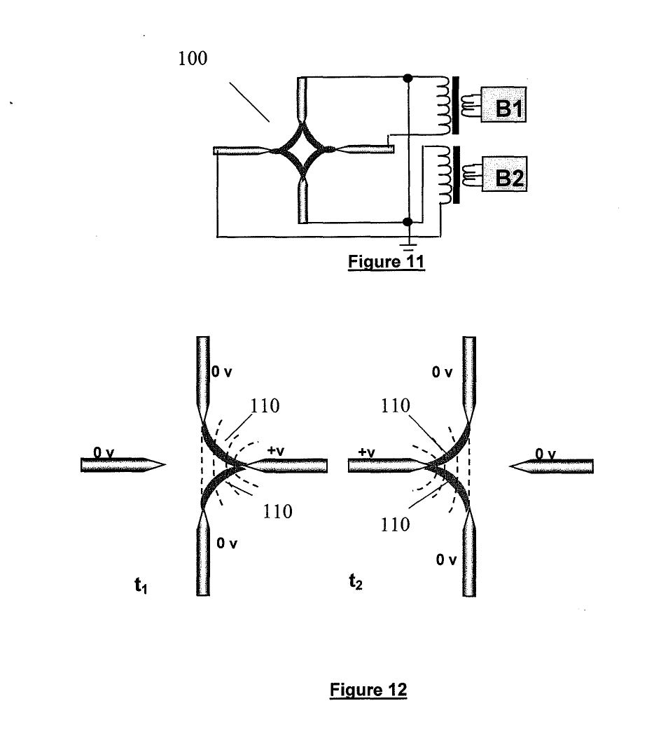

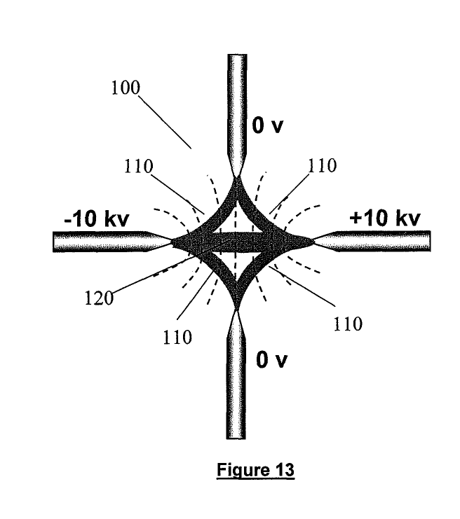

In this exemplary embodiment, the right electrode is tied to arc circuit B1 and is energized to a +10 kv level when the opposite electrode is at ground potential, as are both electrodes on the perpendicular vertical axis. In this case the energized right electrode will arc to both of the electrodes on the perpendicular vertical axis, since those two electrode points of discharge represent a shorter arc path as compared to the path to the opposite horizontal electrode. This is shown in FIG. 12 as time t1. Conversely, the left electrode is tied to arc circuit B2 which is “ON” when B1 is “OFF”. When the B2 circuit is energized, the left electrode is energized to a voltage of +10 kv and arcs to the two vertical axis electrodes. This is shown as time t2 in FIG. 12. The waveform of the applied signal is the same as in FIG. 9B.

The B1 and B2 circuits are operated out of phase with each other in a similar fashion to the previously-described exemplary embodiment of the invention depicted in FIG. 8, which uses arc circuits A and B, each of which utilize a pair of high voltage generators 1, for a total of 4 high voltage arc discharge units. In this exemplary embodiment, the central (straight) arc paths never form, and the very center region of the total arc field 100 is relatively cooler, as shown graphically in FIG. 14.

Such a low energy region may be optimized for the relatively low temperature required for fiber stripping but may not allow sufficient energy for splicing. However, removal of the vertically oriented electrode pair would configure the arc system exactly the same as the presently available arc fusion splicing technology, thereby allowing fusion splicing to also be conducted using the standard method with operation using a single high voltage generator 1.

### Sixth Exemplary Embodiment

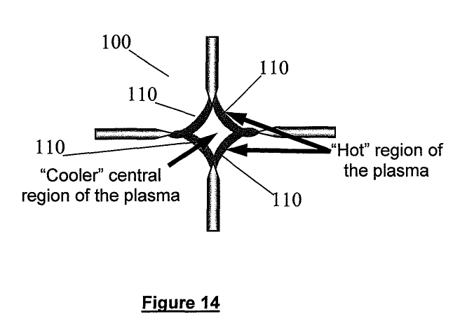

Alternatively, in a sixth exemplary embodiment of the invention, with a similar electrical design to that described above for the first alternative exemplary embodiment, both arc generation high voltage circuits, comprising high voltage generators 1, might be operated simultaneously but with one generating a negative voltage. This is similar to the operation using Circuit B of the fourth exemplary embodiment of the invention. In this case the straight central arc path 120 is strongly ionized between the positive and negative electrodes, and the “side-lobe” arc paths 110 are also formed from the energized electrodes to the grounded electrodes on the perpendicular axis. In this condition, there should be sufficient energy for fiber splicing at the center of the arc field. This operating condition is shown in FIG. 13.

Alternatively, the high voltage generators 1 can be operated out of phase, with both energized in a positive voltage output mode to produce the pattern described in the fifth exemplary embodiment of the invention in order to produce a weak energy state at the center of the plasma field for fiber stripping operations. By this means, one exemplary embodiment of the invention can be operated in two different fundamental modes, one optimized for high energy splicing operations, and one optimized for low temperature fiber stripping. This exemplary embodiment therefore offers greater flexibility than the first alternative exemplary embodiment. It may offer similar versatility to the first exemplary embodiment of the invention, with lower cost, but somewhat reduced operating range and stability.

Control System

FIG. 7 is a block diagram of an exemplary control system for the exemplary embodiments of the present invention. In FIG. 7, a controller 5, which may controlled by a personal computer (PC 6), or independently, controls the high voltage generators 1. The high-voltage generators 1 generate an arc frequency in accordance with the signal received from the controller 5. This exemplary control system allows the user to vary the arc frequency and pulse frequency of any of the exemplary embodiments of the invention, and hence adjust the power of the resulting plasma field 100.

The controller can incorporate a microchip which is a digitally controlled potentiometer (such as a XICOR™ X9315W or equivalent) that drives a Voltage Controlled Oscillator (VCO).

Benefits

Using the present invention, significant benefits may be realized that will solve many problems with conventional fusion arcs, and open up new applications for arc usage:

A fairly stable central plasma field will be created at the center of the electrode arrangement. The field will be relatively insensitive to the condition and age of any of the electrodes since it will result from the interaction of all of the electrodes, with multiple arc paths, including arc “side lobes” to any grounded electrodes. Hence, electrode life is significantly extended and may almost cease to be an issue of relevance to the user.

For similar reasons, the plasma field generated by the present invention should have greater stability in terms of both arc position and energy intensity. Therefore use of the new arc technology should result in a splicing or fiber stripping process with greater process stability, repeatability, and dependability. This should improve the success rate and process yield.

Because of the greater stability resulting from the maintenance of a field of ionized air at the cross-point of the electrode pattern, it is possible to maintain a stable arc field with a lower electrical power delivered to the electrodes. Thus the arc is stable at a lower energy threshold than what is achievable with a conventional arc circuit. Therefore, the arc circuit of the present invention allows a low arc field intensity that is suitable for stripping plastic coating off of a fiber (at perhaps 900° C.) without melting or damaging the surface of the glass fiber. Despite this capability, the arc circuit of the present invention is also capable of producing a very high arc power (such as >1600° C.) for glass fiber splicing.

When configured with an electrode gap of 3.5 to 3.8 mm, it is possible to create a continuously stable plasma field with a diameter for perhaps 2.1 mm or greater in the plane of the electrodes. This will be sufficient to allow splicing operations to be performed with very large fibers (with diameters of 1.5 mm or more) that are required for very high-powered fiber lasers and other applications. The present invention therefore can be retrofit for present fusion splicers to accommodate a wide variety of large diameter fibers.

The electrode configurations described in the exemplary embodiments are compatible with conventional dual perpendicular field-of-view camera observations systems presently established and in use in fusion splicers for fiber pre-splice observation & alignment and post-splice quality analysis.

The capability of the arc circuit of the present invention to generate either high or low power plasma field intensities will allow a single arc fusion splicer to splice standard optical fibers as well as very large fibers, which require high power and temperature, and also very small fibers or low melting point glass fibers (such as phosphate or fluorine-based glass, or micro-structured “holey” fibers), which require a low temperature/low energy arc.

Various applications are possible to take advantage of this technology:

The arc discharge technology of the present invention can allow creation of an extremely versatile arc fusion splicer with applicability to almost any optical fiber, as indicated above.

The arc discharge of the present invention can be applied for fiber or wire stripping, reshaping of optical fibers or other materials, optical fiber mode field diameter expansion, surface polishing including fiber optic connector polishing, tapering of glass rods, tubes and optical fibers as well as fusing and tapering multiples thereof, and other applications where the benefits of controlling the plasma shape and the intensity or temperature of the plasma field may be useful.

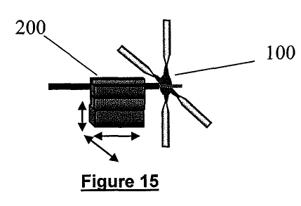

A high performance fiber stripper can be created by utilizing the low power arc capability of the present invention. In the exemplary embodiment shown in FIG. 15, a fiber translation stage 200 is added to traverse the fiber through the arc field 100 to expose the fiber to the arc stripping energy down the length of the fiber. In the Figure, this exemplary embodiment is shown with 3-axis fiber translation capability. However, an actual device may need only a single motor to traverse the fiber lengthwise through the arc field 100. The stripping temperature can be controlled by both arc current and duration. A component of duration can be the translation speed. It may be necessary to use a pulsed total arc duty cycle to achieve a sufficiently low temperature. In the case of a non-continuous arc, an ion generator (not shown) might be utilized to facilitate arc ignition.

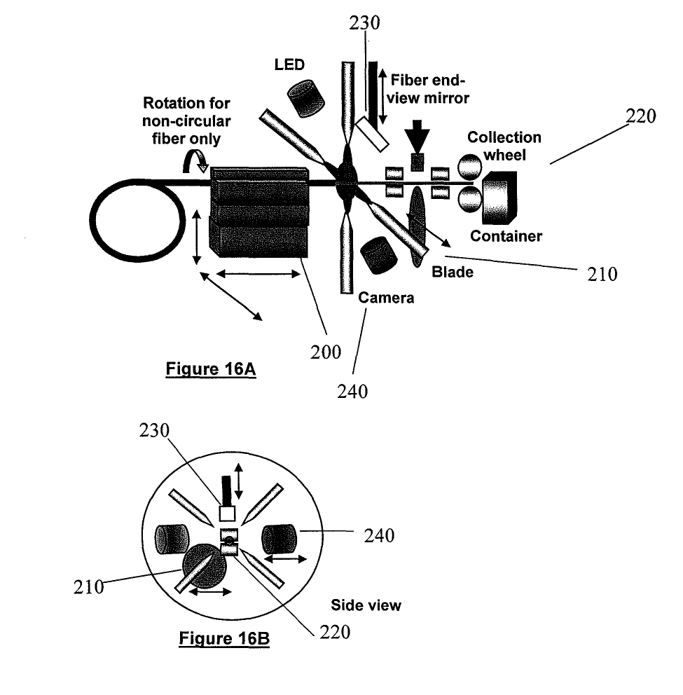

A high performance fiber preparation system can be achieved by adding a cleaver to the fiber stripping and cleaning system described above. In the case of the exemplary embodiment shown in FIGS. 16A and B, a standard telecommunications type cleaver is used that employs a traversing circular blade 210 and a bending-stress method of cleave propagation. However, a tensile-stress method cleaver can be just as easily integrated. In the Figure, a scrap collection system 220 is used to automatically dispose of the cleaved-off fiber shard. The exemplary embodiment also includes a movable mirror 230 with camera system 240 for inspecting the end of the fiber after cleaving. In this exemplary embodiment, the system also includes a motorized stage 200 to rotate the fiber about its axis so that a polarization maintaining fiber (not shown) can be rotationally aligned to a particular polarization axis by taking advantage of the end-view mirror 230 and camera inspection system 240.

Ultimately, the capability of the present invention to generate low temperature arcs suitable for fiber stripping as well as high temperature arcs suitable for splicing even large diameter fibers could be utilized to create a single unit capable of preparing (that is, stripping, cleaning, and cleaving) fibers and subsequently splicing the fibers. Such a system would encompass all the capabilities of both (1) and (3) above and could therefore offer a compact and cost effective solution to complete splicing automation. This could advance the general technology of splicing by completely removing operator sensitivity from the process.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method for generating a plasma field, comprising:
arranging at least three electrodes to create an arc discharge;
connecting at least one of the electrodes to ground; and
applying voltage to each electrode not connected to ground.

2. A method according to claim 1, wherein each electrode not connected to ground receives voltage from a power supply independent of the other electrodes.

3. A method according to claim 1, wherein only one electrode is connected to ground.

4. A method according to claim 1, wherein the power of the plasma field is controlled by varying an applied signal.

5. A method according to claim 1, wherein at least one of the power, intensity, shape, and the size of the plasma field is varied in relation to the number of electrodes to which voltage is applied.

6. A method according to claim 1, wherein the power of the plasma field is controlled by modulating an applied signal.

7. A method according to claim 1, wherein the plasma field has a temperature and shape suitable for splicing optical fibers.

8. A method according to claim 1, wherein the plasma field has a temperature and shape suitable for stripping a coating layer off of an underlying material.

9. A method according to claim 1, wherein the plasma field has a temperature and shape suitable for tapering optical fibers, rods, or tubes.

10. A method according to claim 1, wherein the plasma field has temperature and shape suitable for fusing together and tapering a plurality of at least one of optical fibers, rods, and tubes.

11. A method according to claim 1, wherein the plasma field has a temperature and shape suitable for thermally expanding the core and mode field diameter of an optical fiber.

12. A method according to claim 1, wherein the plasma field has a temperature and shape suitable for softening or partially melting and thereby reshaping an object.

13. The method of claim 12 wherein said object is an optical fiber.

14. A method according to claim 1, wherein the plasma field has a temperature and shape suitable for softening or partially melting and thereby polishing the surface of an object.

15. The method of claim 14 wherein said object is at least one of an optical fiber and optical fiber connector end.

16. A method according to claim 1, wherein the plasma field has a temperature and shape suitable for cleaning or etching the surface of an object.

17. The method of claim 16 wherein said object is an optical fiber.

18. A method for generating a plasma field, comprising:
arranging at least four electrodes to create an arc discharge;
connecting at least one of the electrodes to ground; and
applying voltage to each electrode not connected to ground,
wherein points of discharge of at least three of the electrodes define a plane, and
wherein a point of discharge of at least one of the electrodes is disposed outside of the plane.

19. A method according to claim 18, wherein each electrode not connected to ground receives voltage from a power supply independent of the other electrodes.

20. A method according to claim 18, wherein only one electrode is connected to ground.

21. A method according to claim 18, wherein the power of the plasma field is controlled by varying an applied signal.

22. A method according to claim 18, wherein at least one of the power, intensity, shape, and the size of the plasma field is varied in relation to the number of electrodes to which voltage is applied.

23. A method according to claim 18, wherein the power of the plasma field is controlled by modulating an applied signal.

24. A method according to claim 18, wherein the plasma field has a temperature and shape suitable for splicing optical fibers.

25. A method according to claim 18, wherein the plasma field has a temperature and shape suitable for stripping a coating layer off of an underlying material.

26. A method according to claim 18, wherein the plasma field has a temperature and shape suitable for tapering optical fibers, rods, or tubes.

27. A method according to claim 18, wherein the plasma field has temperature and shape suitable for fusing together and tapering a plurality of at least one of optical fibers, rods, and tubes.

28. A method according to claim 18, wherein the plasma field has a temperature and shape suitable for thermally expanding the core and mode field diameter of an optical fiber.

29. A method according to claim 18, wherein the plasma field has a temperature and shape suitable for softening or partially melting and thereby reshaping an object.

30. The method of claim 29 wherein said object is an optical fiber.

31. A method according to claim 18, wherein the plasma field has a temperature and shape suitable for softening or partially melting and thereby polishing the surface of an object.

32. The method of claim 31 wherein said object is at least one of an optical fiber and optical fiber connector end.

33. A method according to claim 18 wherein the plasma field has a temperature and shape suitable for cleaning or etching the surface of an object.

34. The method of claim 33 wherein said object is an optical fiber.

35. An apparatus for generating a plasma field, comprising:
a power supply;
at least two powered electrodes connected to the power supply; and
at least one grounded electrode connected to ground,
wherein a point of discharge of each of the powered electrodes and a point of discharge of the at least one grounded electrode are arranged to create an arc discharge between points of discharge.

36. An apparatus for generating a plasma field, comprising:
a power supply;
at least three powered electrodes connected to the power supply; and
at least one grounded electrode connected to ground,
wherein the point of discharge of the powered electrodes and a point of discharge of the at least one grounded electrode are arranged to create an arc discharge between the points of discharge,
wherein the points of discharge of at least three of the electrodes are arranged to form a plane, and
wherein the point of discharge of at least one of the electrodes is disposed outside of the plane.

37. A method for generating a plasma field, comprising:
arranging point of discharge of two pairs of electrodes to create an arc discharge between the points of discharge; and
applying voltage alternately between the pairs of electrodes at a predetermined frequency.

38. A method according to claim 37, wherein when voltage is applied to an electrode pair, one electrode is connected to positive voltage and the other electrode is connected to negative voltage.

39. A method according to claim 37,
wherein a straight path of plasma is formed between opposing electrodes, and peripheral paths of plasma are formed between nonopposing electrodes.

40. A method according to claim 37,
wherein one electrode in each pair is continuously grounded.

41. A method for generating a plasma field, comprising:
arranging points of discharge of a first and second pair of electrodes to create an arc discharge between the points of discharge;
applying a positive voltage to the first electrode pair; and
applying a negative voltage to the second electrode pair.

42. A method for generating a plasma field, comprising:
arranging points of discharge of a first and second pair of electrodes to create an arc discharge between the points of discharge; and
applying an equal voltage to the first and second electrode pair, wherein the voltage applied to one electrode pair is out of phase with the voltage applied to the other electrode pair.
